(19) United States
(12) Patent Application Publication
(10) Pub. No.: US 2007/0066150 A1
(43) Pub. Date: Mar. 22, 2007

(54) Coupling structure

(75) Inventors: Liming Le, Taipei (TW); Yung Chi Yang, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 11/391,551

(22) Filed: Mar. 29, 2006

(30) Foreign Application Priority Data
Sep. 19, 2005 (TW) 94216081

(51) Int. Cl. H01R 4/48

(52) U.S. Cl. 439/819

(57) ABSTRACT

A coupling structure for coupling a first housing to a second housing is provided, which includes a plurality of hooking portions formed on the first housing, and a plurality of coupling portions formed on the second housing and corresponding to the hooking portions. Each of the coupling portions has a coupling surface, wherein the coupling surface of at least one of the coupling portions faces toward a first direction different from a second direction of the coupling surface of another one of the coupling portions. The hooking portions can be coupled to the coupling surfaces of the coupling portions so as to fasten the first housing to the second housing.

### FIELD OF THE INVENTION

The present invention relates to coupling structures, and more particularly, to a coupling structure for securely fastening a plurality of housings together.

### BACKGROUND OF THE INVENTION

In response to the requirements of miniaturization and multi-functionality for an electronic device, various types of components, which may belong to different technical fields, should be integrated to form the electronic device. In such case, the various types of components are usually fabricated by different manufacturers and are then integrated by means of housings thereof. Accordingly, the assembly mechanism and electrical connection between different components are important for the performance of the electronic device, especially the way of assembling the housings of the components.

A common method for assembling the housings of the components is to use hooks to couple the housings to each other, wherein a plurality of hooks arranged in the same direction are normally adopted to provide a predetermined coupling effect. As shown in FIG. 8, a row of hooks 10 are disposed on an edge of a first housing 3 and can be coupled to a second housing 5 to fasten the first housing 3 to the second housing 5.

However, the above hook-coupling structure may unexpectedly have the hooks uncoupled from the second housing themselves, making the first housing not securely fastened to the second housing. Accordingly, additional locking members such as screws are usually used together with the hooks to secure the coupling between the housings.

The use of additional locking members such as screws desirably secures the hooks to the second housing, but increases the costs on material, time and operation for assembling the housings of the components together, as well as the assembly structure between the components becomes complicated by the additional screws.

Therefore, the problem to be solved here is to provide a coupling structure, which can securely couple two housings to each other and is simple and cost-effective to implement.

### SUMMARY OF THE INVENTION

In light of the foregoing drawbacks in the prior art, a primary objective of the present invention is to provide a coupling structure for securely fastening a plurality of housings together.

Another objective of the present invention is to provide a coupling structure easy to be assembled.

Still another objective of the present invention is to provide a simple coupling structure.

A further objective of the present invention is to provide a low-cost coupling structure.

In order to attain the above and other objectives, a coupling structure is proposed in the present invention to couple a first housing to a second housing. The coupling structure comprises a plurality of coupling portions formed on the second housing, each of the coupling portions having a coupling surface, wherein the coupling surface of at least one of the coupling portions faces toward a first direction different from a second direction of the coupling surface of another one of the coupling portions; and a plurality of hooking portions formed on the first housing and corresponding to the coupling portions respectively, each of the hooking portions for being coupled to the coupling surface of a corresponding one of the coupling portions, so as to fasten the first housing to the second housing. The first direction is preferably opposite to the second direction.

The coupling surface of each of the coupling portions is formed with an opening, wherein the opening can be of a rectangular shape. Each of the hooking portions comprises a protruded portion for being coupled to the opening of the coupling surface of the corresponding one of the coupling portions, wherein the hooking portions can be L-shaped hooks.

Each of the coupling portions may further comprise a guiding surface adjacent to the coupling surface thereof, for guiding the protruded portion of each of the hooking portions to be coupled to the opening of the coupling surface of the corresponding one of the coupling portions. The guiding surface can be a slant surface.

In one embodiment, the coupling portions are linearly arranged on the second housing and located closely to each other. In another embodiment, the coupling portions are spaced at intervals from each other on the second housing.

Particularly, the coupling structure of the present invention comprises a first coupling portion formed on the second housing and having a coupling surface facing toward a first direction; a second coupling portion formed on the second housing and having a coupling surface facing toward a second direction different from the first direction of the coupling surface of the first coupling portion; a first hooking portion formed on the first housing and corresponding to the first coupling portion, the first hooking portion for being coupled to the coupling surface of the first coupling portion; and a second hooking portion formed on the first housing and corresponding to the second coupling portion, the second hooking portion for being coupled to the coupling surface of the second coupling portion. The first direction is preferably opposite to the second direction.

Therefore, the coupling structure of the present invention comprises the plurality of coupling portions having coupling surfaces facing toward different directions (e.g. opposite directions) and the plurality of hooking portions for being coupled to the coupling portions so as to securely fasten the first housing to the second housing, such that the problem of unsatisfactory coupling effect through the use of the same-directional hooks in the prior art can be solved. Further, the linearly arranged coupling portions of the coupling structure may advantageously reduce the width of the coupling structure. Moreover, the coupling structure of the present invention is simple and easy to be assembled by hands/fingers, without increasing the costs on material, time and operation for fastening the housings together and without having the complicated structural and assembly arrangement, unlike the prior art. Thus, by the use of the coupling structure of the present invention, the first housing can be securely coupled to the second housing and the advantages such as easy assembly, simplified structure and reduced costs are provided.

### BRIEF DESCRIPTION OF DRAWINGS

The present invention can be more fully understood by reading the following detailed description of the preferred embodiments, with reference made to the accompanying drawings, wherein:

FIG. 1 is a schematic exploded diagram of a coupling structure applied to housings according to a first preferred embodiment of the present invention;

FIG. 2 is a schematic diagram of the coupling structure shown in FIG. 1 to be assembled;

FIGS. 3A and 3B are a front view and a side view of the coupling structure shown in FIG. 1 being assembled, respectively;

FIG. 4 is a schematic exploded diagram of a coupling structure applied to housings according to a second preferred embodiment of the present invention;

FIG. 5 is a schematic diagram of the coupling structure shown in FIG. 4 being assembled;

FIG. 6 is a schematic diagram of a coupling structure applied to housings according to a third preferred embodiment of the present invention;

FIG. 7 is a schematic diagram of the coupling structure shown in FIG. 6 being assembled; and

FIG. 8 (PRIOR ART) is a schematic diagram of a conventional coupling structure.

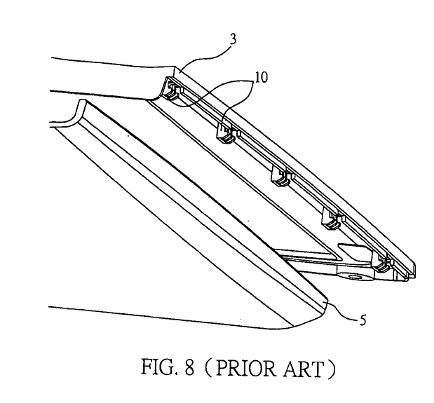

### DETAILED DESCRIPTION OF PREFERRED EMBODIMENTS

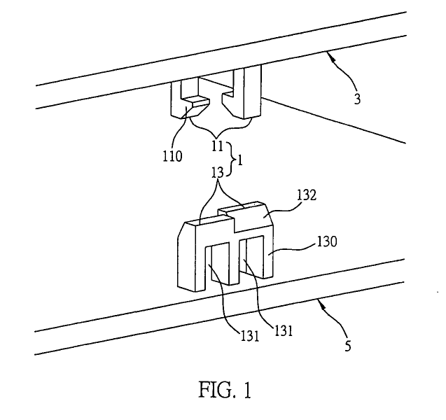

Preferred embodiments of a coupling structure proposed in the present invention for coupling a plurality of housings to each other are described as follows with reference to FIGS. 1 to 7. It should be noted that the drawings are simplified schematic diagrams and only show components relating to the present invention, and the arrangement of components could be more complicated in practical implementation.

### First Embodiment

FIGS. 1, 2, 3A and 3B show a coupling structure 1 according to a first preferred embodiment of the present invention.

As shown in FIG. 1, the coupling structure 1 is used to couple a first housing 3 to a second housing 5, and comprises a plurality of hooking portions 11 and a plurality of coupling portions 13.

In this embodiment, two hooking portions 11 and two coupling portions 13 corresponding to the hooking portions 11 are provided. The two hooking portions 11 are disposed on the first housing 3, wherein each of the hooking portions 11 is formed with a protruded portion 110 and can be L-shaped. The two coupling portions 13 are disposed on the second housing 5 and can be coupled to the hooking portions 11 respectively so as to fasten the first housing 3 to the second housing 5. The coupling portions 13 are linearly arranged on the second housing 5 and disposed closely to each other. Each of the coupling portions 13 comprises a coupling surface 130, wherein the coupling surface 130 of one of the coupling portions 13 faces toward a first direction different from a second direction of the coupling surface 130 of the other coupling portion 13, and the first direction is preferably opposite to the second direction. Further, the coupling surface 130 of each of the coupling portions 13 is formed with an opening 131 such that the protruded portion 110 of each of the hooking portions 11 can be coupled to the opening 131 of the coupling surface 130 of the corresponding one of the coupling portions 13. The opening 131 can have a rectangular shape. Moreover, each of the coupling portions 13 may comprise a guiding surface 132 adjacent to the coupling surface 130 thereof, for guiding the protruded portion 110 of each of the hooking portions 11 to be coupled to the opening 131 of the coupling surface 130 of the corresponding one of the coupling portions 13. The guiding surface 132 is preferably a slant surface.

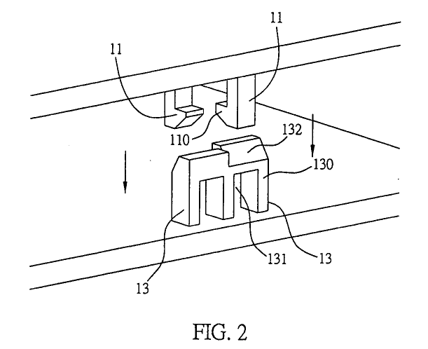

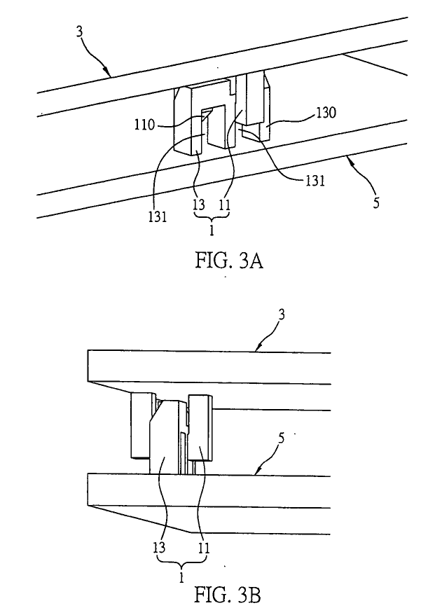

To fasten the first housing 3 to the second housing 5, as shown in FIG. 2, it only needs to move the hooking portions 11 on the first housing 3 toward the corresponding coupling portions 13 on the second housing 5 so as to couple the protruded portions 110 of the hooking portions 11 to the openings 131 of the coupling surfaces 130 of the coupling portions 13, and during such process, the protruded portions 110 of the hooking portions 11 may reach the guiding surfaces 132 of the coupling portions 13 and are guided by the guiding surfaces 132 to smoothly reach the coupling surfaces 130 such that the protruded portions 110 can successfully be engaged with the openings 131 of the coupling portions 13. The assembled coupling structure 1 with the hooking portions 11 being coupled to the coupling portions 13 is shown in FIGS. 3A and 3B. As the coupling portions 13 have the coupling surfaces 130 facing toward different directions (e.g. opposite directions), a bi-directional coupling effect is provided for securely fastening the first housing 3 and the second housing 5 together by the coupling structure 1. And as the coupling portions 13 are linearly arranged on the second housing 3, the width of the coupling structure 1 can be reduced.

The coupling portions 13 disposed closely to each other on the second housing 5 may be separately or integrally formed. The integrally formed coupling portions 13 are in the form of a single coupling portion having a plurality of openings 131, which may further reduce the width of the coupling structure 1.

It should be understood that the present invention is not limited to the use of openings 131 and protruded portions 10 for coupling the coupling portions 13 and the hooking portions 11 to each other as described in the above first embodiment, and any other coupling mechanisms such as ring and hook, recess and projection, groove and flange, and so on can realize the same coupling effect for the coupling structure of the present invention.

Therefore, the coupling structure 1 according to the first embodiment of the present invention simply uses two hooking portions 11 and two coupling portions 13 having coupling surfaces 131 facing toward different directions (e.g. opposite directions) to fasten the first housing 3 to the second housing 5. This arrangement provides a bi-directional coupling effect for securely fastening the first housing 3 and the second housing 5 together, thereby eliminating the use of screws and the problem of unexpected uncoupling of the hooks from the second housing as in the prior art. Moreover, the coupling structure 1 is structurally simple and can easily be assembled by hands or fingers, without increasing the costs on material, time and operation for fastening housings together and without having the complicated structural and assembling arrangement, unlike the prior art. Thus, by the use of the coupling structure 1 of the first embodiment, the first housing can be securely coupled to the second housing and the advantages such as easy assembly, simplified structure and reduced costs are provided.

### Second Embodiment

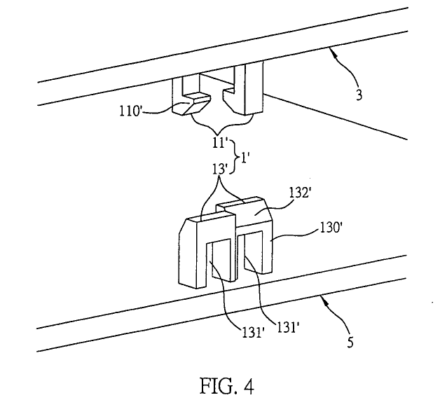

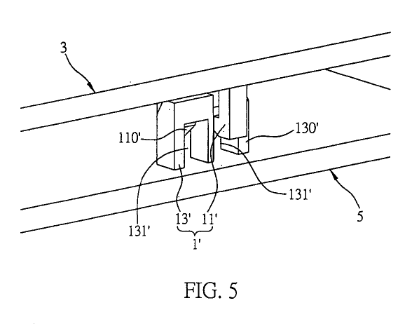

FIGS. 4 and 5 show a coupling structure 1′ according to a second preferred embodiment of the present invention. The coupling structure 1′ is similar to the coupling structure 1 of the first embodiment, with a primary difference in that the two coupling portions 13′ of the coupling structure 1′ of the second embodiment are spaced from each other on the second housing 5, instead of the closely arranged coupling portions 13 of the coupling structure 1 of the first embodiment.

As shown in FIG. 4, the coupling structure 1′ of the second embodiment is similarly used to couple the first housing 3 to the second housing 5, and includes two hooking portions 11′ formed on the first housing 3, and two coupling portions 13′ formed on the second housing 5 and corresponding to the hooking portions 11′. The structural arrangement of the hooking portions 11′ and the coupling portions 13′ (such as protruded portions 110′, coupling surfaces 130′, openings 131′, guiding surfaces 132′, etc.) and the coupling mechanism between the hooking portions 11′ and the coupling portions 13′ are same as those described in the first embodiment and not to be further repeated here. The assembled coupling structure 1′ as shown in FIG. 5 has the two coupling portions 13′ having the coupling surfaces 130′ thereof facing toward different directions (e.g. opposite directions) and coupled to the two hooking portions 11′, thereby similarly providing a bi-directional coupling effect for securely fastening the first housing 3 to the second housing 5.

As the two coupling portions 13′ of the coupling structure 1′ are spaced from each other, the fastening effect provided for the first and second housings 3, 5 can further be enhanced. It should be understood that there is no particular limitation on the distance between the two coupling portions 13′, which may depend on the size of the first and second housings 3, 5 or any other requirement in practice.

By the use of the coupling structure 1′ of the second embodiment, the first housing can be securely coupled to the second housing and the advantages such as easy assembly, simplified structure and reduced costs are provided.

### Third Embodiment

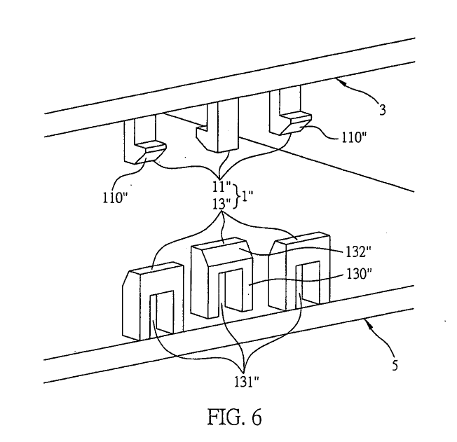

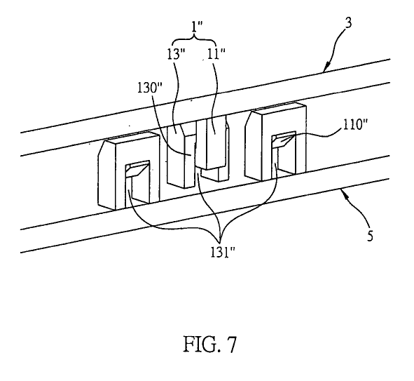

FIGS. 6 and 7 show a coupling structure 1″ according to a third preferred embodiment of the present invention. The coupling structure 1″ is similar to the coupling structures 1, 1′ of the first and second embodiments, with a primary difference in that three hooking portions 11″ and three coupling portions 13″ are used for the coupling structure 1″ in the third embodiment.

As shown in FIG. 6, the coupling structure 1″ of the third embodiment is similarly used to couple the first housing 3 to the second housing 5, and includes three hooking portions 11″ formed on the first housing 3, and three coupling portions 13″ formed on the second housing 5 and corresponding to the hooking portions 11″. Each of the hooking portions 11″ is formed with a protruded portion 110″ and can be L-shaped. The coupling portions 13″ can be coupled to the hooking portions 11″ respectively so as to fasten the first housing 3 to the second housing 5. In this embodiment, the three coupling portions 13″ are preferably spaced at intervals on the second housing 5. Each of the coupling portions 13″ comprises a coupling surface 130″, wherein the coupling surface 130″ of at least one of the coupling portions 13″ faces toward a first direction different from a second direction of the coupling surface 130 of another one of the coupling portions 13″, and the first direction is preferably opposite to the second direction. Further, the coupling surface 130″ of each of the coupling portions 13″ is formed with an opening 131″ such that the protruded portion 110″ of each of the hooking portions 11″ can be coupled to the opening 131″ of the coupling surface 130″ of the corresponding one of the coupling portions 13″. The opening 131″ can have a rectangular shape. Moreover, each of the coupling portions 13″ may comprise a guiding surface 132″ adjacent to the coupling surface 130″ thereof, for guiding the protruded portion 110″ of each of the hooking portions 11″ to be coupled to the opening 131″ of the coupling surface 130″ of the corresponding one of the coupling portions 13″. The guiding surface 132″ is preferably a slant surface.

To fasten the first housing 3 to the second housing 5, it only needs to move the hooking portions 11″ on the first housing 3 toward the corresponding coupling portions 13″ on the second housing 5 so as to couple the protruded portions 110″ of the hooking portions 11″ to the openings 131″ of the coupling surfaces 130″ of the coupling portions 13″, and during such process, the protruded portions 110″ of the hooking portions 11″ may reach the guiding surfaces 132″ of the coupling portions 13″ and are guided by the guiding surfaces 132″ to smoothly reach the coupling surfaces 130″ such that the protruded portions 110″ can successfully be engaged with the openings 131″ of the coupling portions 13″. The assembled coupling structure 1″ with the hooking portions 11″ being coupled to the coupling portions 13″ is shown in FIG. 7. As the coupling portions 13″ have the coupling surfaces 130″ facing toward different directions (e.g. opposite directions), a bi-directional coupling effect is provided for securely fastening the first housing 3 and the second housing 5 together by the coupling structure 1″. Moreover, the coupling effect for the first and second housings 3, 5 is further enhanced through the use of more hooking portions 11″ and more coupling portions 13″ in the third embodiment as compared to the above first and second embodiments. It should be noted that the present invention may also use more than three hooking portions and more than three coupling portions for the coupling structure, and these hooking portions and coupling portions can be arranged dispersedly or in groups, so as to provide better coupling effect for fastening the first and second housings together. Thereby, the present invention allows the coupling structure to have flexible arrangement of hooking portions and coupling portions thereof in response to different requirements on the coupling between the first and second housings.

Therefore, the coupling structure of the present invention comprises the plurality of coupling portions having coupling surfaces facing toward different directions (e.g. opposite directions) and the plurality of hooking portions for being coupled to the coupling portions so as to securely fasten the first housing to the second housing, such that the problem of unsatisfactory coupling effect through the use of the same-directional hooks in the prior art can be solved. Further, the linearly arranged coupling portions of the coupling structure may advantageously reduce the width of the coupling structure. Moreover, the coupling structure of the present invention is simple and easy to be assembled by hands/fingers, without increasing the costs on material, time and operation for fastening the housings together and without having the complicated structural and assembly arrangement, unlike the prior art. Thus, by the use of the coupling structure of the present invention, the first housing can be securely coupled to the second housing and the advantages such as easy assembly, simplified structure and reduced costs are provided.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A coupling structure for coupling a first housing to a second housing, the coupling structure comprising:
a plurality of coupling portions formed on the second housing, each of the coupling portions having a coupling surface, wherein the coupling surface of at least one of the coupling portions faces toward a first direction different from a second direction of the coupling surface of another one of the coupling portions; and
a plurality of hooking portions formed on the first housing and corresponding to the coupling portions respectively, each of the hooking portions for being coupled to the coupling surface of a corresponding one of the coupling portions.

2. The coupling structure of claim 1, wherein the coupling surface of each of the coupling portions is formed with an opening, and each of the hooking portions comprises a protruded portion for being coupled to the opening of the coupling surface of the corresponding one of the coupling portions.

3. The coupling structure of claim 2, wherein the hooking portions are L-shaped.

4. The coupling structure of claim 2, wherein each of the coupling portions further comprises a guiding surface adjacent to the coupling surface thereof, for guiding the protruded portion of each of the hooking portions to be coupled to the opening of the coupling surface of the corresponding one of the coupling portions.

5. The coupling structure of claim 4, wherein the guiding surface is a slant surface.

6. The coupling structure of claim 1, wherein the first direction is opposite to the second direction.

7. The coupling structure of claim 1, wherein the coupling portions are arranged closely to each other on the second housing.

8. The coupling structure of claim 1, wherein the coupling portions are spaced at intervals from each other on the second housing.

9. A coupling structure for coupling a first housing to a second housing, the coupling structure comprising:
a first coupling portion formed on the second housing and having a coupling surface facing toward a first direction;
a second coupling portion formed on the second housing and having a coupling surface facing toward a second direction different from the first direction of the coupling surface of the first coupling portion;
a first hooking portion formed on the first housing and corresponding to the first coupling portion, the first hooking portion for being coupled to the coupling surface of the first coupling portion; and
a second hooking portion formed on the first housing and corresponding to the second coupling portion, the second hooking portion for being coupled to the coupling surface of the second coupling portion.

10. The coupling structure of claim 9, wherein the coupling surface of the first coupling portion is formed with an opening, and the first hooking portion comprises a protruded portion for being coupled to the opening of the coupling surface of the first coupling portion.

11. The coupling structure of claim 10, wherein the first hooking portion is L-shaped.

12. The coupling structure of claim 10, wherein the first coupling portion further comprises a guiding surface adjacent to the coupling surface thereof, for guiding the protruded portion of the first hooking portion to be coupled to the opening of the coupling surface of the first coupling portion.

13. The coupling structure of claim 12, wherein the guiding surface of the first coupling portion is a slant surface.

14. The coupling structure of claim 9, wherein the coupling surface of the second coupling portion is formed with an opening, and the second hooking portion comprises a protruded portion for being coupled to the opening of the coupling surface of the second coupling portion.

15. The coupling structure of claim 14, wherein the second hooking portion is L-shaped.

16. The coupling structure of claim 14, wherein the second coupling portion further comprises a guiding surface adjacent to the coupling surface thereof, for guiding the protruded portion of the second hooking portion to be coupled to the opening of the coupling surface of the second coupling portion.

17. The coupling structure of claim 16, wherein the guiding surface of the second coupling portion is a slant surface.

18. The coupling structure of claim 9, wherein the first direction is opposite to the second direction.

19. The coupling structure of claim 9, wherein the first coupling portion is arranged closely to the second coupling portion.

20. The coupling structure of claim 9, wherein the first coupling portion is spaced from the second coupling portion.
